(19) United States
(12) Patent Application Publication
(10) Pub. No.: US 2011/0025847 A1
(43) Pub. Date: Feb. 3, 2011

(54) SERVICE MANAGEMENT USING VIDEO PROCESSING

(75) Inventors: Youngchoon Park, Brookfield, WI (US); John I. Ruiz, New Berlin, WI (US)

Correspondence Address: FOLEY & LARDNER LLP, 777 EAST WISCONSIN AVENUE, MILWAUKEE, WI, 53202-5306, US

(73) Assignee: Johnson Controls Technology Company

(21) Appl. No.: 12/847,803

(22) Filed: Jul. 30, 2010

Related U.S. Application Data
(60) Provisional application No. 61/230,475, filed on Jul. 31, 2009.

(51) Int. Cl. H04N 7/18; G06Q 10/00

(52) U.S. Cl. 348/143; 705/8; 348/E07.085

(57) ABSTRACT

A service management system includes a camera capturing video of the site. The service management system further includes a monitoring system remote from the camera and the site. The service management system also includes a video processing system configured to analyze the video for one or more conditions and, in response to a determination that the one or more conditions have been met, to cause a data message to be sent to the monitoring system. The monitoring system is configured to cause a service event relating to the one or more conditions to be scheduled for the site.

### CROSS-REFERENCE TO RELATED PATENT APPLICATIONS

The present application claims the benefit of U.S. Provisional Application No. 61/230,475, filed Jul. 31, 2009, the entirety of which is hereby incorporated by reference.

### BACKGROUND

The present disclosure generally relates to the fields of service management and video processing.

Service management systems conventionally rely on employee initiation of service requests. That is, an employee at a site (e.g., gas station, retail store, residence, movie theater, office building, etc.) must typically call a remote service provider when the employees at the site recognize a problem. During this call, the remote service provider schedules a service appointment with the caller and service is conducted at some later date.

### SUMMARY

One embodiment of the present invention relates to a computer system for providing service management to a site. The computer system includes a camera capturing video of the site. The system further includes a monitoring system remote from the camera and the site. The system also includes a video processing system configured to analyze the video for one or more conditions and, in response to a determination that the one or more conditions have been met, to cause a data message to be sent to the monitoring system. The monitoring system is configured to cause a service event relating to the one or more conditions to be scheduled for the site.

Another embodiment relates to a method for providing service management to a site. The method includes capturing video of the site using a video camera and providing the video to a video processing system. The method further includes using the video processing system to analyze the video for one or more conditions. The method also includes using the analysis to determine whether the one or more conditions have been met. The method yet further includes causing a data message to be sent to a monitoring system from the video processing system in response to a determination that the one or more conditions have been met. The method further includes using the monitoring system to cause a service event relating to the one or more conditions to be scheduled for the site.

Yet another embodiment relates to a computer system for providing service management to a site having a plurality of lights. The computer system includes a camera and a processing system configured to receive frames captured by the camera and to process the frames over a period of time to detect frame locations that correspond to lights. The processing system is further configured to monitor the frame locations that are detected to correspond to lights to determine whether one or more of the lights are off at a time when the lights are scheduled to be on. The processing system is further configured to transmit a notification message in response to a determination that the one or more lights are off at a time when the lights are scheduled to be on. The processing system may be configured to count determinations that the one or more lights are off over a period of time and to refrain from transmitting the notification message in response to the determination that the one or more lights are off unless the count is above a threshold value. The computer system may further include a monitoring system configured to receive the notification message and to cause a service event to be scheduled in response to the notification message.

Yet another embodiment relates to a computer system for monitoring a worker driven process. The computer system includes a camera and a processing system configured to receive video of an area to be serviced by an employee and to identify a worker object within the received video by comparing an object within the video to pre-defined worker templates. The processing system is further configured to analyze the activity of the identified worker object to determine whether the activity fits within a set of process parameters for the worker driven process. The processing system is further configured to provide a result of the determination to at least one of another system, a memory device, or a formatted report.

Alternative exemplary embodiments relate to other features and combinations of features as may be generally recited in the claims.

### BRIEF DESCRIPTION OF THE FIGURES

The disclosure will become more fully understood from the following detailed description, taken in conjunction with the accompanying figures, wherein like reference numerals refer to like elements, in which:

FIG. 1A is a block diagram of a system for providing service management to a site or sites, according to an exemplary embodiment;

FIG. 1B is a block diagram of another system for providing service management to a site or sites, according to another exemplary embodiment;

FIG. 2A is a detailed block diagram of a video processing system that may be used with the overall systems of FIG. 1A or 1B, according to an exemplary embodiment;

FIG. 2B is another detailed block diagram of a video processing system that may be used with the overall systems of FIG. 1A or 1B, according to another exemplary embodiment;

FIG. 3 is a block diagram of another system for providing service management to a site or sites, according to another exemplary embodiment;

FIG. 4A is an illustration of a user interface for a monitoring system or video processing system of the present disclosure, according to an exemplary embodiment;

FIG. 4B is a flow chart of a exemplary process for establishing video object templates to be used in, for example, user tasks or condition checking processes of the video processing system or the monitoring system;

FIG. 4C is a flow chart of a process for generating and processing a user query using, e.g., the user interface of FIG. 4A, according to an exemplary embodiment;

FIG. 5 is a flow chart of a process for using a video monitoring system, according to an exemplary embodiment;

FIG. 6 is a flow chart of a process for validating a scheduled maintenance event, according to an exemplary embodiment;

FIG. 7 is a flow chart of a process for using a video processing system to validate the work of a service contractor, according to an exemplary embodiment;

FIG. 8 is a flow chart of a process for using a video processing system to validate functionality of an air or water unit, according to an exemplary embodiment;

FIG. 9A is a flow chart of a process for using a video processing system to detect an activity of an employee, according to an exemplary embodiment;

FIG. 9B is a flow chart of a process for using a video processing system to classify a video object, according to an exemplary embodiment;

FIG. 10 is a flow chart of a process for checking light functionality, according to an exemplary embodiment;

FIG. 11 is a flow chart of a process for using a video processing system to conduct sign and sign light detection, according to an exemplary embodiment; and

FIG. 12 is a flow chart of a process for using a video processing system to determine if a light is out and send a notification regarding a lighting outage, according to an exemplary embodiment.

### DETAILED DESCRIPTION OF THE EXEMPLARY EMBODIMENTS

Before turning to the figures, which illustrate the exemplary embodiments in detail, it should be understood that the disclosure is not limited to the details or methodology set forth in the description or illustrated in the figures. It should also be understood that the terminology is for the purpose of description only and should not be regarded as limiting.

Referring generally to the figures, a system for providing service management from a remote service management system to a site is shown. The system includes one or more cameras capturing video of the site. The video is provided from the cameras to a video processing system (e.g., local to the site). The video processing system is configured to analyze the video for one or more conditions. When the video processing system determines that one or more conditions have been met, the video processing system is configured to cause a data message to be sent to a remote monitoring system. The data message may include a request for service at the site or information describing the determined conditions. The remote monitoring system is configured to cause service to be scheduled at the site (e.g., with a service provider local to the site) using the received data message. Advantageously, human workers at a site do not need to recognize the need for service or to manually schedule a service appointment. The systems and methods described herein can advantageously provide faster and more consistent service to a network of sites (e.g., gas stations distributed around a large geographic area).

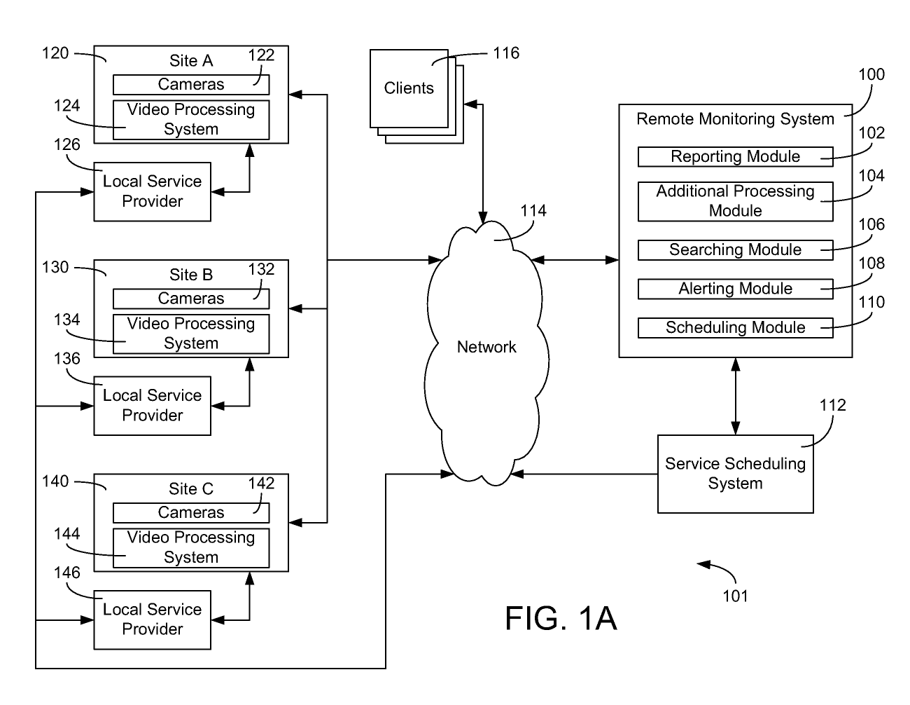

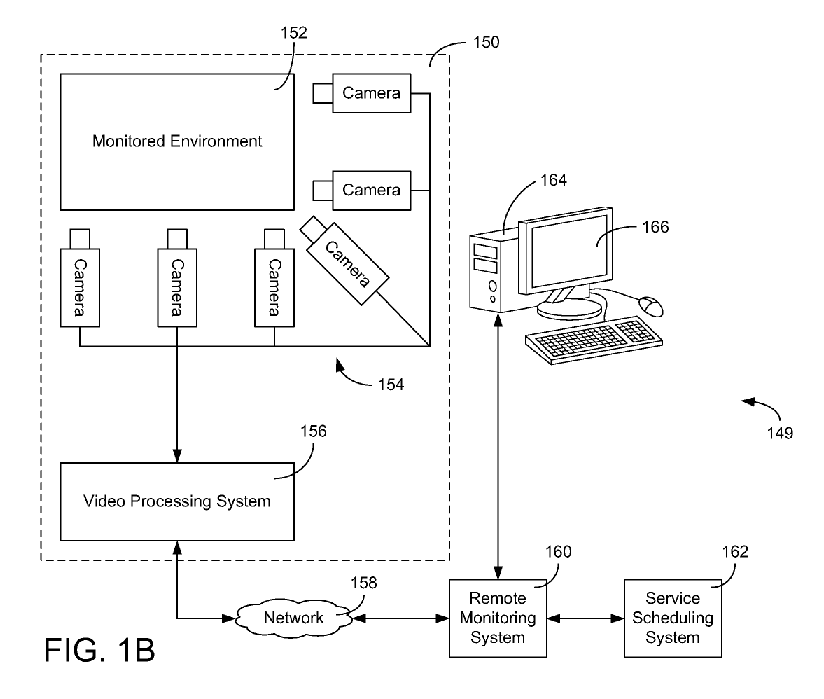

Referring to FIG. 1A, a block diagram of a system 101 for providing service management to a site 120 or sites 120, 130, 140 is shown, according to an exemplary embodiment. Each site 120, 130, 140 includes at least one camera 122, 132, 142, a local video processing system 124, 134, 144, and an environment monitored by the cameras 122, 132, 142. Each site is also connected to a network or networks 114 (e.g., Internet, LAN, WAN, wireless network, etc.) through which sites 120, 130, 140 and a remote monitoring system 100 can conduct data communications.

Local video processing systems 124, 134, 144 may be configured to analyze captured video for one or more conditions. In response to a determination that the one or more conditions have been met (e.g., sign lights are not working properly or are burnt out, gas station canopy lights are not working properly or are burnt out, the bathroom has not been cleaned recently, etc.), video processing systems 124, 134, 144 may cause a data message to be sent to remote monitoring system 100 via network 114. Remote monitoring system 100 is configured to cause a service event relating to the one or more conditions to be scheduled at the site. In an exemplary embodiment, remote monitoring system 100 is remote from specific sites 120, 130, 140 and serves all of the plurality of sites 120, 130, 140.

In the embodiment shown in FIG. 1A, remote monitoring system 100 includes modules 102-110 for using the data messages received from sites 120, 130, 140. Reporting module 102 is configured to generate a report based on the received data messages. For example, if a video processing system at one of the sites detects a faulty light, the video processing system of the site may provide notification regarding the faulty light to remote monitoring system 100. A report may then be generated by reporting module 102 (e.g., daily, weekly, monthly, etc.) describing the faulty light (e.g., when the light was first noticed to be faulty, the location of the faulty light, the replacement part number for the light, how many similar lights may be due for a bulb change at the site, etc.). Remote monitoring system 100 may cause the report to be e-mailed or otherwise transmitted to a person responsible for maintenance at the site, a supervisor of the site, a regional supervisor, a client computer, a portable electronic device (e.g., PDA, mobile phone, etc.), or a service scheduling system 112.

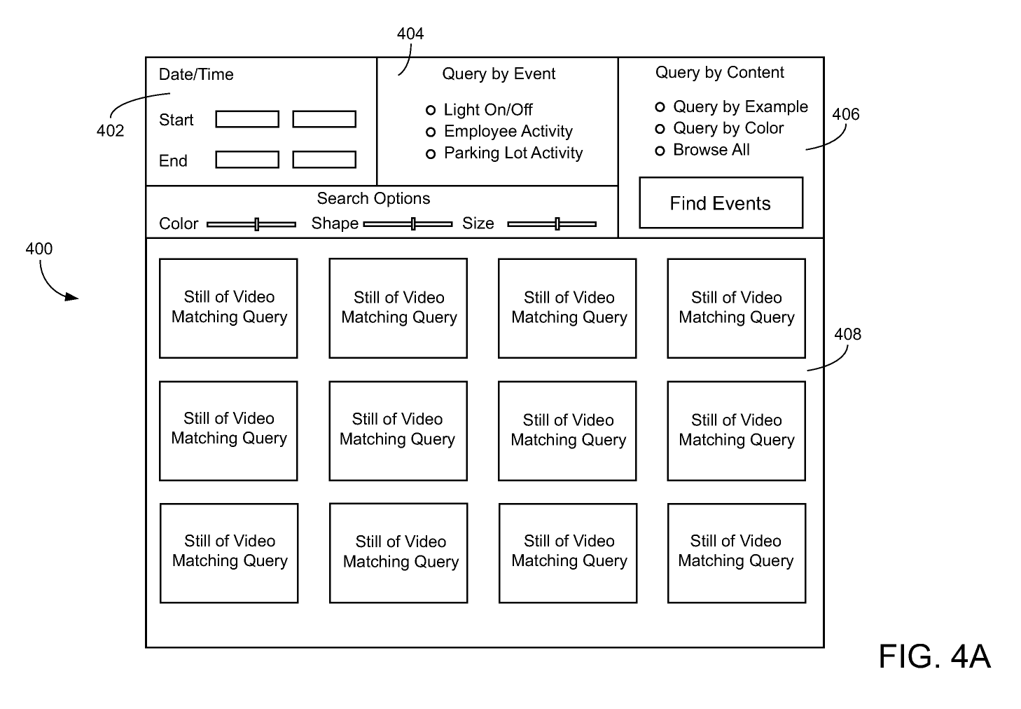

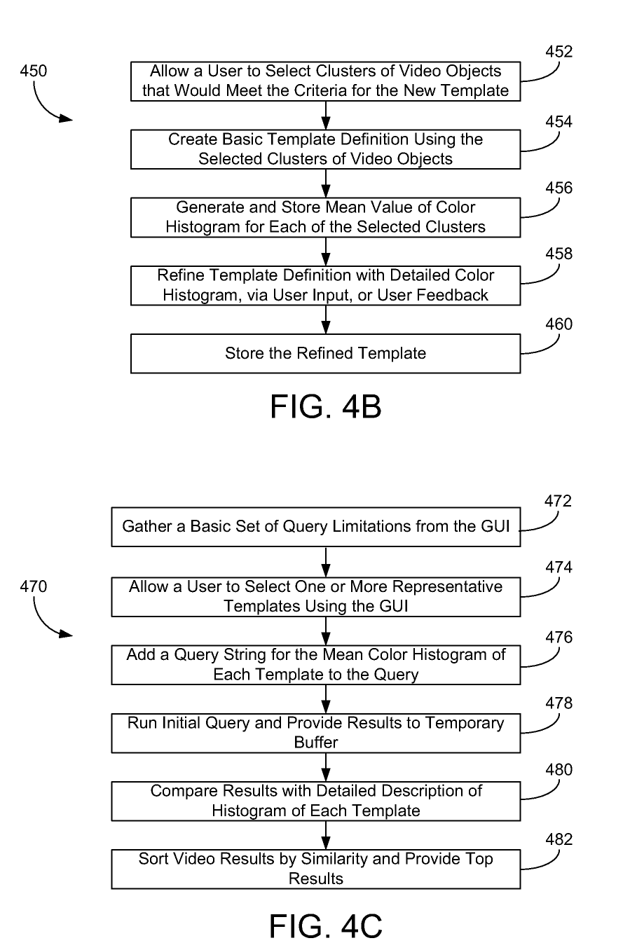

Remote monitoring system 100 also includes a searching module 106 configured to allow remote users at monitoring system 100 (or connected to the monitoring system via, e.g., clients 116) to conduct searching of video and events collected by remote monitoring system 100 from video processing systems 124, 134, 144 of the plurality of sites 120, 130, 140. Video searching using a graphical user interface provided by searching module 106 is described, e.g., with reference to FIG. 4A.

Remote monitoring system 100 is further shown to include an alerting module 108. Alerting module 108 may be used to generate an alert regarding a data message received from a site (e.g., from video processing system 124 at site 120). For example, if video processing system 124 determines that a light is out at site 120, alerting module 108 may generate an alert for providing to another device, a display screen, or another system (e.g., scheduling system 112) that includes information about the lighting determination.

Service scheduling system 112 is coupled to remote monitoring system 100 and receives alerts, reports, or other data from remote monitoring system 100. Service scheduling system 112 may use the received data to schedule service with one or more local service providers 126, 136, 146. For example, service scheduling system 112 may generate a transmission that requests maintenance on a site 120 based on the received data about items that need servicing. If a light is out at site 120, for example, service scheduling system 112 may create an appointment request for the light to be fixed and send the appointment request to local service provider 126 for action. Local service provider 126 may receive the request and take any number of steps to follow through with the appointment (e.g., contacting the site to confirm the appointment, arriving at the site the next business day, etc.) or to confirm the appointment with service scheduling system 112. In other exemplary embodiments, service scheduling system 112 may negotiate a particular service time or date with the local service provider, with a representative of the site, or with a centralized manager responsible for a plurality of sites (e.g., a franchise owner). An appointment request from service scheduling system 112 may include diagnostic information based on the video processing. For example, video processing system 124, remote monitoring system 100, or service scheduling system 112 can indicate to local service provider 126 which lights should be inspected, the type of the lights for replacement, or other results of the video processing. In some exemplary embodiments remote monitoring system 100 can provide video or frames from video to service scheduling system 112 or local service provider 126 (e.g., so a worker can see which light is out, that the light is not out but is simply obscured by a tree branch, etc.).

Remote monitoring system 100 further includes a scheduling module 110. Scheduling module 110 may have the same functionality or functionality similar to service scheduling system 112 and may be local to remote monitoring system 100 as opposed to being remote from remote monitoring system 100. According to various exemplary embodiments, only one of scheduling module 110 and service scheduling system 112 may be included in system 101. In other embodiments, both module 110 and system 112 may be used in concert. Remote monitoring system 100 further includes an additional processing module 104 for any further processing activity (e.g., logic configuration, video processing in addition to that provided by site specific video processing systems, etc.).

Referring now to FIG. 1B, a block diagram of another system 149 for providing service management to a site or sites is shown, according to an exemplary embodiment. Site 150 is shown in detail with a plurality of cameras 154 and a monitored environment 152. Video cameras 154 are configured (e.g., positioned) to capture video from environment 152. Environment 152 may be an indoor or outdoor area, and may include any number of persons, buildings, signs, lights, retail locations, service locations, cars, spaces, zones, rooms, or any other object or area that may be either stationary or mobile. For example, monitored environment 152 may be a gas station having gas pumping locations that are lit by a canopy lighting system or a store having one or more illuminated signs.

Video cameras 154 may be analog or digital cameras and may contain varying levels of video storage and video processing capabilities. Video cameras 154 are communicably coupled to video processing system 156 (e.g., via a digital connection, via an analog connection, via an IP network, via a wireless connection, etc.). Video cameras 154 may be primarily used for surveillance and security purposes and secondarily used for service management purposes. In other exemplary embodiments, video cameras 154 may be dedicated to service management purposes while other video cameras in a space are dedicated to tasks such as surveillance and security. In yet other embodiments, video cameras 154 are primarily used for service management purposes and secondarily used for surveillance and security purposes. According to an exemplary embodiment, each of video cameras 154 are configured to monitor different areas, objects, aspects, or angles within monitored environment 152. For example, one camera may be configured to monitor sign lights for a gas station while another camera may be configured to monitor canopy lights for the gas station.

Video processing system 156 receives video from video cameras 154. In some embodiments, video processing system 156 also receives meta information from video cameras 154. Video processing system 156 is generally configured to conduct a variety of processing tasks on data (e.g., video and meta information) received from video cameras 154. The processing tasks may include preparing the video for display on a graphical user interface that can be shown on an electronic display 166 of a client terminal 164. Via display 166, video processing system 156 can provide local or remote video monitoring, searching, and retrieval features to a user of system 149. While client terminal 164 having display 166 is shown as communicating with remote monitoring system 160 in FIG. 1B, in other embodiments client terminal 164 may receive information served by video processing system 156 or service scheduling system 162.

Video processing system 156 is shown as connected to a network 158. Via network 158, video processing system 156 transmits alerts and other generated data based on video information received from the plurality of cameras 154. Additional cameras associated with another monitored environment area or otherwise may be connected to network 158. For example, other monitored sites (such as those shown in FIG. 1A) may be connected to network 158 and also provide video or processing results to remote monitoring system 160.

Remote monitoring system 160 receives data from video processing system 156 related to a detected condition associated with site 150. Remote monitoring system 160 may notify a user of a condition in monitored environment 152 that should be addressed (e.g., a light that is out, a broken air handling unit, etc.). Client terminal 164 and display 166 are shown connected to remote monitoring system 160 and may receive and display information from remote monitoring system 160 (e.g., for a user of video processing system 156, for a site owner or operator, etc.). In an exemplary embodiment, remote monitoring system 160, client terminal 164, and display 166 are remote from site 150.

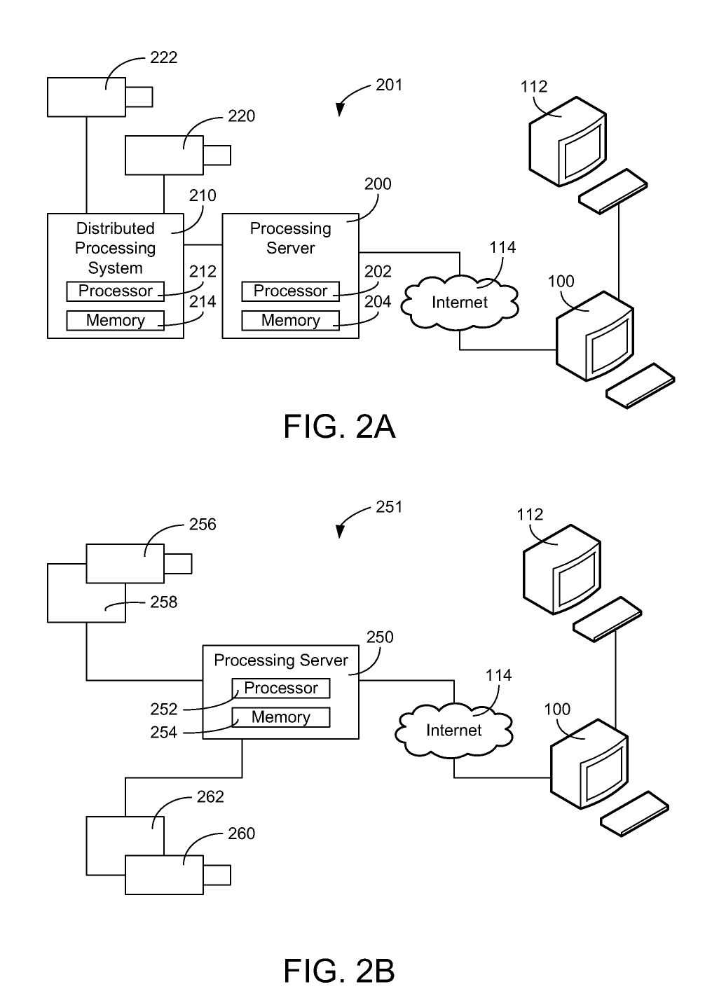

Referring now to FIG. 2A, a video processing system 201 that may be used with the overall systems of FIG. 1A or 1B is shown, according to an exemplary embodiment. In FIG. 2A, digital or analog cameras 220, 222 are shown as communicably coupled to a distributed processing system 210. Distributed processing system 210 is shown communicably coupled to a central processing server 200. Distributed processing system 210 may be configured to conduct a first level of processing (e.g., basic processing, basic object recognition, de-noising, normalizing, compression, etc.) while processing server 200 is configured to conduct more complex processing tasks (e.g., object recognition, movement analysis, frame-by-frame analysis, etc.). In other exemplary embodiments distributed processing system 210 may be configured to conduct more complex video processing tasks (e.g., object recognition and scene description by processing raw video frames) while processing server 200 operates on the results of the complex video processing (video plus meta information provided by distributed processing system 210).

Remote monitoring system 100 is connected to server 200 (e.g., via a direct connection, a network connection, a wired connection, a wireless connection, a LAN, a WAN, or by any other connection scheme). Remote monitoring system 100 may be connected to video processing server 200 via an Internet 114 connection. Distributed processing system 210 and processing server 200 are shown to include processors 212, 202 and memory 214, 204. Remote monitoring system 100 and service scheduling system 112 may have a relationship, as described with reference to previous Figures.

Processors 212, 202 (as well as any other processors described herein) may be responsible for executing software programs such as application programs and system programs to provide computing and processing operations to their host computing systems. Processors 212, 202 can include or be implemented as a general purpose processor, a chip multiprocessor, a dedicated processor, an embedded processor, a media processor, a field programmable gate array (FPGA), a programmable logic device (PLD), or another processing device in alternative embodiments. Processors 212, 202 may be responsible for executing software programs such as application programs and system programs to provide the computing and processing operations of their host devices. System programs assist in the running of the computer system. System programs may be directly responsible for controlling, integrating, and managing the individual hardware components of the computer system. Examples of system programs may include, for example, an operating system (OS), device drivers, programming tools, utility programs, compilers, software libraries, application programming interfaces, a graphical user interface environment, a username/password protection program, security programs, communications programs, and so forth. System programs may be or include any suitable OS (e.g., a Microsoft Windows OS, a Linux OS, a Java OS, an Apple OS, etc.). The application programs may include computer code (e.g., executable code, script code, source code, object code) configured to cause the processor to complete the various logic activities described herein (e.g., the flow chart steps for a video processing system shown in certain Figures and described below).

Memory 214, 204 may be coupled to processors 212, 202 (respectively) and configured to store one or more software programs (e.g., application programs, systems programs, etc.) to be executed by the processors 212, 202. The memory 214, 204 may be implemented using any machine readable or computer-readable media capable of storing data such as volatile memory, removable or non-removable memory, erasable or non-erasable memory, writable or re-writable memory, and so forth. Examples of machine readable storage media may include, without limitation, random-access memory (RAM), dynamic RAM (DRAM), read-only memory (ROM), flash memory, or any other type of media suitable for storing information. Although memory 214, 204 is shown as being separate from processors 212, 202, in various embodiments some portion or the entire memory may be included on the same integrated circuit as the processor. Alternatively, some portion or the entire memory may be disposed on an integrated circuit or other medium (e.g., hard disk drive) external to the integrated circuit of the processor.

Any of the servers, cameras, systems or devices shown herein that communicate with other servers, cameras, systems, devices, or networks further include communications electronics. The communications electronics may include any number of ports, jacks, modulators, demodulators, transceivers, receivers, transmitters, encoders, communications processors or other electronics for completing the communications activities described herein. For example, when processing server 200 provides data to Internet 114 or monitoring system 100, processing server 200 utilizes its communications electronics to complete such data communication. Processor 202 may be configured to control such data communications (e.g., in response to requests or commands from application programs, systems programs, etc.). Any of the systems (e.g., video processor, remote management, service scheduling, etc.) may be processor-based implementations.

Referring now to FIG. 2B, another detailed block diagram of a video processing system 251 that may be used with the overall systems of FIG. 1A or 1B is shown, according to another exemplary embodiment. The video processing system 251 may include digital or analog video cameras 256, 260 communicably coupled to a processing server 250. Video cameras 256, 260 may include different levels of video processing capabilities ranging from having zero embedded processing capabilities (i.e., a camera that provides an unprocessed input to a processing system) to having a significant camera processing component 258, 262. When a significant amount of video processing is conducted away from a central processing server, the video processing system may be referred to as a distributed video processing system (e.g., the distributed processing system of FIG. 2A). According to various exemplary embodiments, the majority of the video processing is conducted in a distributed fashion at the sites to be analyzed. According to other exemplary embodiments, over eighty percent of the processing is conducted in a distributed fashion. Highly distributed video processing may allow video processing systems to scale to meet user needs without significantly upgrading a central server or network. In yet other exemplary embodiments, the video processing is conducted primarily by a processing server and is not substantially distributed away from the processing server. Processing server 250 includes a processor 252 and memory 254 (e.g., which may be configured similarly to those described above with respect to FIG. 2A).

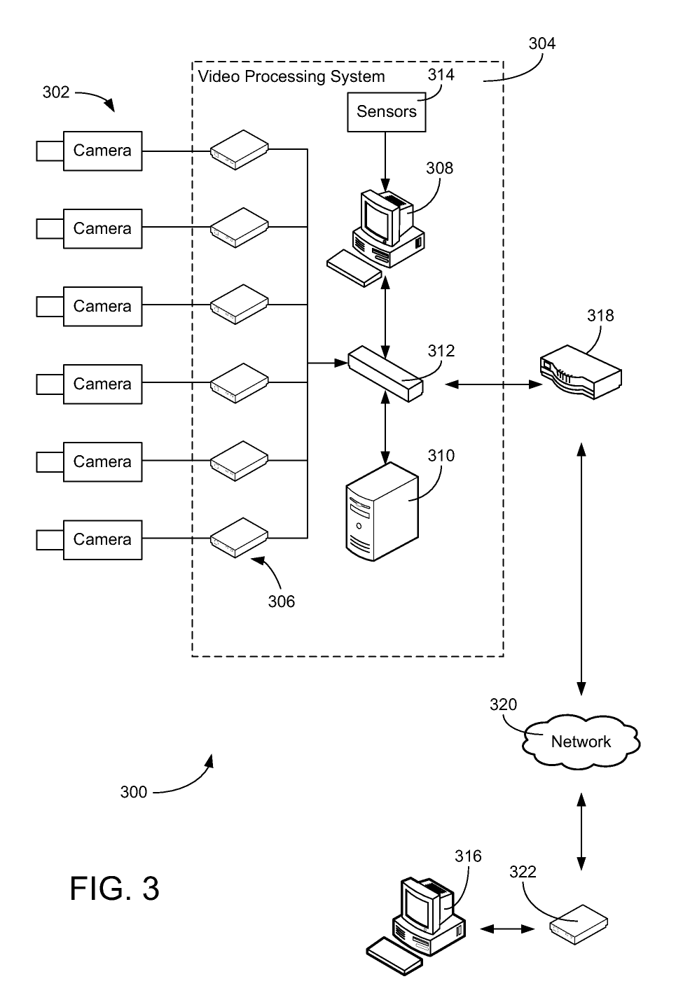

Referring to FIG. 3, a block diagram of another system for providing service management to a site or sites is shown, according to another exemplary embodiment. A plurality of video cameras 302 are shown coupled to a plurality of video analytic modules 306. In the embodiment shown, a video analytics module 306 is provided for each camera 302. According to various other exemplary embodiments, multiple cameras may be coupled to a single video analytics module or multiple video analytics modules may be coupled to a single camera. Video cameras 302 are configured to provide video (e.g., full motion video, partial motion video, periodic frame captures, etc.) of a monitored environment (a site, a portion of a site, a set of objects at a site, etc.) to video analytic modules 306. According to one exemplary embodiment, one or more of video cameras 302 may be pan, tilt, and zoom (PTZ) cameras. Other of cameras 302 may be fixed angle cameras with or without zoom capabilities. If the cameras are analog cameras, an analog output signal may be provided to video analytics modules 306 and converted to digital for analytics and processing. If the cameras are digital cameras, a digital output signal may be provided to video analytics modules 306. In some embodiments the cameras are IP (Internet protocol) cameras configured to provide video information to video analytics modules 306 via IP communications.

In addition to video analytic modules 306, video processing system 304 is shown to include a video analytic event server 308 and a video management system 310. Video analytic modules 306 are connected to a network switch 312 for transmitting data received from video cameras 302. Video analytic event server 308 is shown coupled to switch 312 and may be configured to receive camera data (e.g., actual video information, meta information generated by the camera, etc.) and analytics data (e.g., processing determinations, object descriptions, event descriptors, movement descriptors, condition decisions, preliminary decisions, etc.) from video analytics modules 306. Video analytic event server 308 is configured to use video or analytic data received from video analytics modules 306 to make logical decisions for use by a monitoring system 316. In one example wherein video processing system 304 is used to determine if lights of a site are improperly working, one of video analytics modules 306 may collect and process a small set of video information to estimate whether a light is on or off. The results of such determination, with the relevant set of video information, may be sent to video analytic event server 308. Video analytic event server 308 may archive a large history of video information (e.g., store an archive of frames representative of “lights on” relative to frames representative of “lights off”). Video analytic event server 308 may attempt to confirm that a set of video information estimated to represent a “lights off” event actually represents “lights off” or whether, for example, a tall truck is blocking a camera's view of a camera's canopy light. Therefore, for example, video analytic event server 308 may be able to confirm, check, or otherwise conduct advanced condition determinations using received and archived video and data (e.g., that is subjected to a first level of processing by video analytics modules 306).

One or more sensors 314 may additionally be coupled to video analytic event server 308. The sensor data provided to video analytic event server 308 may be used in addition to the camera data to determine if an event has occurred. For example, an infrared motion sensor may be used in conjunction with data from a video camera to separate object events (e.g., human-based event, light bulb events, etc.) from background events (e.g., leaves blowing, smoke, condensation, glare, etc.).

Video management system 310 may be coupled to cameras 302 and video analytic module 306 via switch 312. Video management system 310 may receive camera data (e.g., video, pictures) and may store or otherwise manage the data for a user of video monitoring system 300. Remote monitoring system 316 may be connected to switch 312 via a router 318, network 320, and high speed connection 322. In some embodiments, video management system 310 may be configured to tag and retain video for playback to a human via a display. Video management system 310 may be configured to, for example, serve graphical user interfaces such as that shown in FIG. 4A and described with reference thereto.

Referring to FIG. 4A, a user interface 400 (e.g., a user interface provided on the electronic display of FIG. 1B) of a monitoring system or a video processing system of the present disclosure is shown, according to an exemplary embodiment. User interface 400 may be generally used as a tool for monitoring an environment for alarms, events, objects, and other properties associated with the environment. User interface 400 may also be used as a configuration tool for establishing queries and conditions for ongoing automation by the processing system or the monitoring system.

User interface 400 may generally include a window 408 for viewing one or more video camera outputs. User interlace 400 additionally includes various search tools 402-406 for sorting and searching for video information captured by cameras at a site. User interface 400 may be used to search for an object in a video or a video scene estimated to include the searched object. User interface 400 may provide a user with video stills of the most recent video examples where the object appears in video (e.g., video separated by a few minutes of time). User interface 400 may also provide search results as video or as a series of representative stills of the retrieved objects or events. User interface 400 may additionally display other search result information. For example, a generated spreadsheet-style report may be viewed on user interface 400 regarding the state of various objects, alerts, conditions, events or a detailed history of a site.

The search may allow for filtering based on the time a certain object or event was detected (e.g., using date/time tool 402). As illustrated in query by event tool 404 or other controls in FIG. 4A, a variety of other criteria may be specified for use in searching (e.g., lighting events, activity or motion in a parking lot or other area of a monitored environment, an employee activity, an object of a certain color, size, and/or shape, etc.). For example, user interface 400 and query by event tool 404 may allow a user to search video based on an employee activity. An example of an employee activity that may be searched is cleaning the bathroom. An event of “cleaning the bathroom” may be triggered when a bright red object (e.g., a human wearing a company shirt) enters the bathroom with a bright green object (a company-supplied cleaning bucket) and does not leave for five minutes.

Queries used by the system may be pre-built or user-built. Such queries may be user built, for example, by using the query by content tool 406. Using the employee cleaning activity described above, for example, a user may first query for video containing certain colors, and tag a representative image received by the color-based query as an example for building an event. For example, a query by color option may allow a user to search for video having a bright red color matching a company shirt color. The user can then select a representative frame of an employee with a company shirt entering the bathroom with the bright green cleaning bucket. The user can then find a representative frame of an employee with a company shirt leaving the bathroom. The user can then build a set of conditions for storage and use as an employee activity. The employee activity may then be queried via user initiation or used in the video processing system for automated video analytics. User interface 400 may be configured to allow the user to build the set of conditions using pseudo code, user interface tools for establishing a timeline, or other software-based methods for describing a condition. In a pseudo-code embodiment, for example, the user may input a string such as “DEFINE_Event cleaning_bathroom=time_between (“emp_bathcleaning_entry.jpg”, “emp_bathcleaning_exit”)>5 minutes.” Such a string might mean that query event cleaning_bathroom is defined to mean a situation where the time between an employee entering a bathroom and an employee leaving the bathroom is greater than five minutes.

FIG. 4B is a flow chart of a exemplary process 450 for establishing video object templates (i.e., “examples”) to be used in, e.g., user tasks or condition checking processes of the video processing system or the monitoring system. The templates may be used to define an object or event that may be found within a frame of video. In other words, a GUI or automated process may search for video similar to a template definition in order to find an object or event. For example, templates defined with process 450 can be utilized when a user selects the “query by example” option of tool 406 shown in FIG. 4A.

Process 450 includes allowing a user to select representative clusters of video objects that would meet the criteria for the new template (step 452). A basic template definition may then be created using the selected clusters of video objects (step 454). For example, a user draws an outline around an employee wearing a red shirt in each of five frames, and the resulting basic template definition may describe an average shape, size, color, or frame position for each of the selected clusters. For each cluster, a histogram may be built to describe the color of the selected cluster and the mean across a plurality of histograms may be stored (step 456). The template may then be defined with detailed histogram information for the plurality of clusters, refined via user input, or refined via user feedback (step 458). For example, a template may be stored with a few representative histograms (e.g., one for each light condition), a few representative object shapes (e.g., one for each size or shape of employee), or stored with other detailed alternative information. In step 460, the refined template is stored and may then be accessed by a user or automated processes for use in video searching.

One or more templates created with process 450 may be shown on user interface 400 of FIG. 4A. The multiple levels of template information described in process 450 may be used to provide improved query speed and accuracy. For example, when the query is run, the system may gather an initial set of results by finding video frames having a mean color histogram value within a broad range of the template's color histogram mean. The system may then conduct a size, shape and color histogram comparison of the detailed template information to the initial set of video results.

Referring now to FIG. 4C, a flow chart of a process 470 for generating and processing a user query (e.g., for entry via the GUI of FIG. 4A) that draws upon a template is shown, according to an exemplary embodiment. Process 470 includes generating a basic set of query limitations (step 472). The basic set of query limitations may include dates, times, cameras, event durations, event tags, or other limitations. The user may then be allowed to select one or more representative templates to use for the search using the GUI (step 474). When the user selects one or more representative templates, the system may find the mean color histogram of each template and add a corresponding query string to the query being built (step 476). An initial query may be run and the results may then be provided to a temporary buffer (step 478). The initial results of the query may be compared with one or more detailed color histogram descriptions of each template (step 480). The results may then be sorted for similarity using the detailed template histograms and the top matching results (e.g., a top 10, a top 100, or any other number of results) may be provided via the user interface to a user (step 482) for further analysis or selection. The query result may include video or video stills of an event associated with the query and various other result properties. For example, video camera information (e.g., video camera ID, video camera location, video camera channel address or number, the time and date of when the video camera captured a relevant event or object, etc.), object or employee information (e.g., an employee ID, employee name, etc.), or other information may be included with the results.

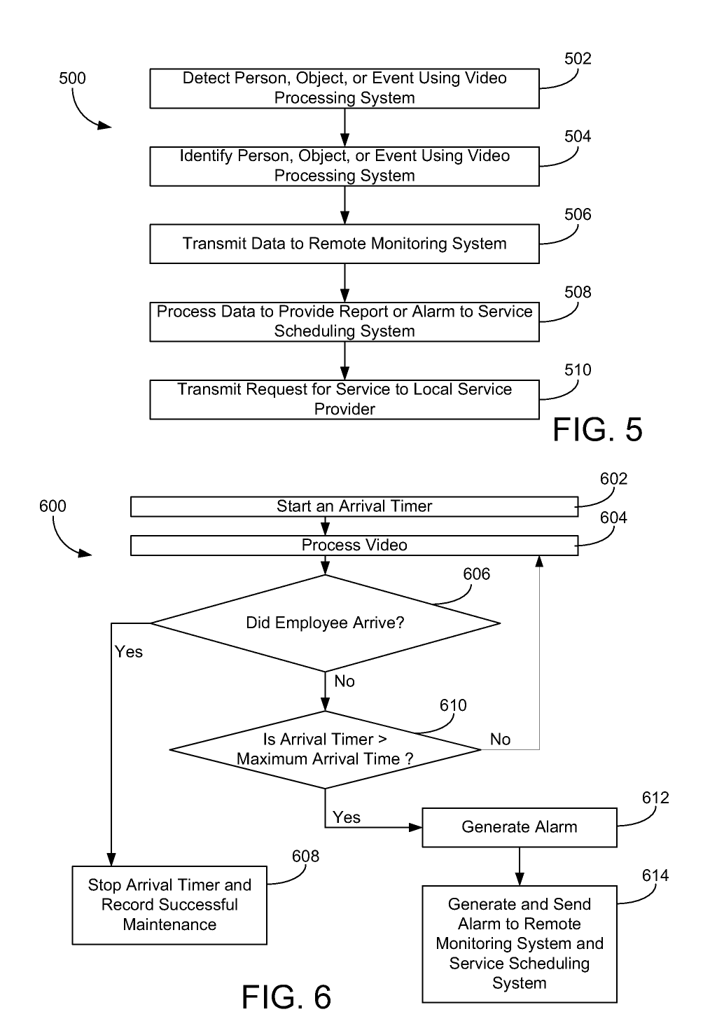

Referring generally to FIGS. 5-12, flow charts of exemplary processes for using the systems of the present disclosure to detect properties of and manage an environment are shown. The systems may use the processes of FIGS. 5-12 to provide alerts regarding equipment or to monitor the status of other objects or assets within an environment.

Referring now to FIG. 5, a flow chart of a process 500 for using a video processing system is shown, according to an exemplary embodiment. A camera of the system detects a person, object, or event within the environment (step 502) and identify the person, object, or event (step 504). Data regarding the person, object, or event is provided to a remote monitoring system (step 506). The data may be an alarm or warning, a report regarding activity of the person, object, or event, or otherwise. The data is processed in order to provide a report or alarm to the service scheduling system (step 508), and the service scheduling system then transmits a request for service to a local service provider of the environment (step 510). For example, if an event such as a malfunctioning light is detected by a camera, the service scheduling system may transmit a request for service to repair the broken light.

Referring to FIG. 6, a flow chart of a process 600 for validating a scheduled maintenance is shown, according to an exemplary embodiment. Process 600 may be used when a schedule exists for maintenance of an area (e.g., a bathroom, a counter, another service station area, etc.). Process 600 is shown to include starting an arrival timer based on the schedule (step 602). For example, a timer may be started every morning at 5:30 am and may run for two hours, giving an employee two hours to complete the morning bathroom cleaning. While the timer is running, the video may be processed to find employee objects (e.g., video frames that match stored templates for the employee objects, etc.) (step 604). The results of the processing are continually checked to determine whether the employee has arrived (step 606). If an employee arrives “on time” to perform maintenance on an area (step 606), the arrival timer is stopped and a successful maintenance of the area may be recorded (step 608). However, if the arrival time exceeds a maximum allowed arrival time before the employee shows up (determined in step 610), an alarm or other report may be generated (step 612). The report may then be sent to a remote monitoring system and service scheduling system indicating a failure to properly maintain an area of the environment (step 614). For example, if an hourly check of the bathroom of an environment is scheduled and no employee shows up over the course of an hour, a report or alarm may be generated regarding the failure. Process 600 may be adapted to include more than one maintenance area. For example, a maintenance schedule may include multiple locations (e.g., three locations such that an employee is scheduled to arrive at one location, maintain the location, then move on to the next location, etc.).

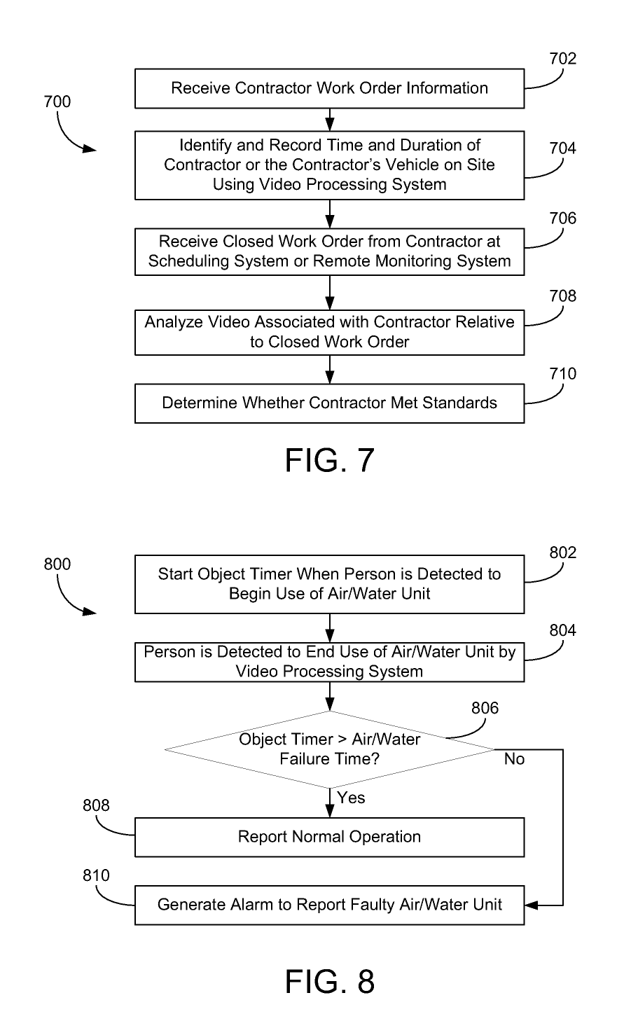

Referring to FIG. 7, a flow chart of a process 700 for validating the work of a contractor is shown, according to an exemplary embodiment. A work order may be issued to a contractor (step 702) from a service scheduling system. The work order may relate to, for example, a broken or dim light at a site. When the work order is issued, a local service provider and site (e.g., a video processing system for the site) may receive the work order. The video processing system on the site may be configured to use one or more cameras to attempt to identify and record the time and duration of a contractor or a contractor's vehicle on the site (step 704). When a closed work order is received from the contractor (indicating that the maintenance associated with the work order is complete)(step 706), the arrival time of the contractor (e.g., contractor's vehicle) along with the duration of time that the contractor was on site is analyzed (step 708). Using such time and duration information, the video monitoring system may determine if the work done by the contractor met standards (e.g., met a minimum contracted amount of time)(step 710). In another example, the observed arrival time and service duration time may be used to verify whether a bill from the contractor is appropriate (e.g., if the contractor billed for one hour of work on site, the cameras may be used to determine if the contractor's vehicle was on site for at least or approximately one hour). As another example, the arrival time may be used to determine if the contractor arrived on site in a timely fashion, or even if the contractor arrived at all. The video monitoring system may also detect whether the contractor made multiple visits to the site.

Referring now to FIG. 8, a flow chart of a process 800 of validating the functionality of an air or water unit at a gas station is shown, according to an exemplary embodiment. An object timer associated with the air or water unit may be started when a user (e.g., a customer at a gas station) is detected to begin use of the unit (step 802). The detection of the user may be accomplished via a video processing system (e.g., including one or more cameras) configured to monitor the area in which the unit is located. When the person ends use of the unit (detected by the video processing system) (step 804), the object timer may be compared to an air/water unit failure time (step 806). If the object timer is greater than the failure time, the video processing system may report a normal air or water unit operation (step 808). If the object timer is not greater than the failure time, the video processing system generates an alarm to report faulty air/water unit operation (step 810). Very short operation time may indicate that the person found the air or water unit to be out of service. The video processing system, the remote monitoring system, or the scheduling service system may send a request for maintenance of the air compressor to a service contractor. In other embodiments, the generated alarm may be provided to the local store manager and request visual inspection of the air or water unit by the manager. The manager may need to respond to the message within a period of time. The manager may be required to respond that no repair is necessary or that repair is actually necessary. While FIG. 8 is described with reference to an air or water unit, other equipment may also be analyzed using the video processing systems described herein.

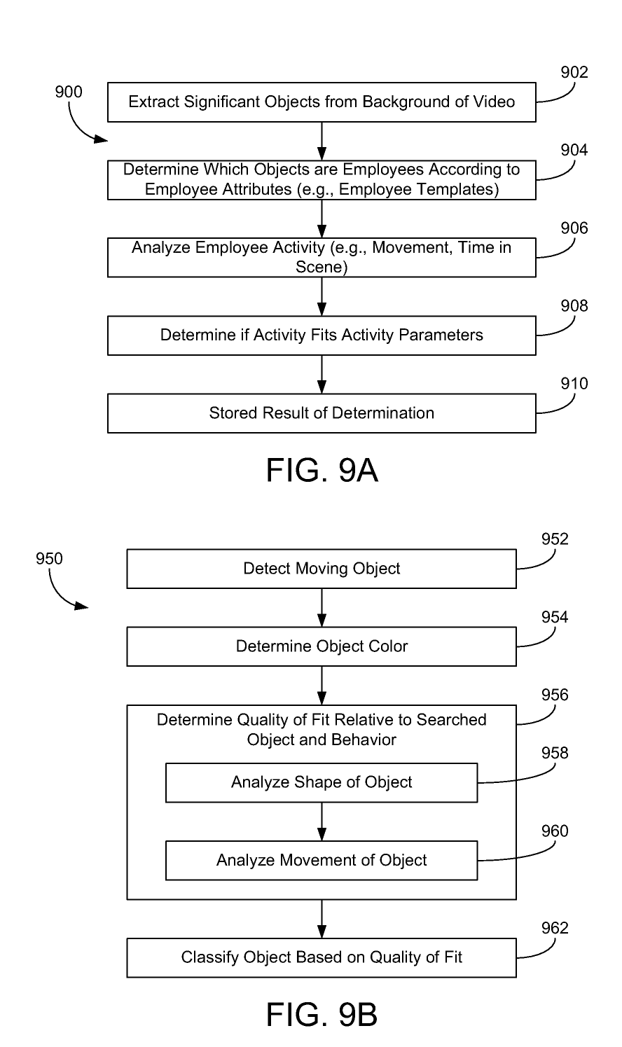

Referring to FIG. 9A, a flow chart of a process 900 for the detection of employee activity is shown, according to an exemplary embodiment. One or more significant objects may be extracted from the background of video from a site (step 902). The objects may be compared to employee attributes (e.g., employee templates, a uniform the employee is wearing, any logo shown on the uniform, another visual identifier associated with the employee, employee templates, etc.) to determine which objects are employees (step 904). Once an employee is identified, the activity of the employee (e.g., movement, time in scene, etc.) may be analyzed by the video processing system (step 906). The analysis of step 906 may include describing the duration and direction and the movement (e.g., defining a movement vector for the employee object). The described object activity may then be compared to activity parameters (e.g., time, direction, speed, etc.)(step 908). The determination of step 908 may be stored in memory (step 910). Storing the determination in memory may include storing the most likely matching activity with an indication of percentage of confidence. For example, if a video processing system determines that the activity most matching an employee movement through video is a bathroom cleaning activity but is only 79% confident in such a match, the video processing system may “tag” the video with “bathroom cleaning—79% confidence.” If a second activity is also possible, a video portion may be tagged with that second activity in addition to the most likely activity. Therefore, when a user runs a search, he or she may be able to visually inspect the video portion with the results for either activity and accept or reject the video processing system's determination.

Referring now to FIG. 9B, a flow chart of a process 950 for object movement detection is shown, according to an exemplary embodiment. Process 950 may be generally used to discover and detect the movement of a person (or another object). Process 950 includes detecting a moving object (step 952) along with the color and other properties of the object (step 954). Detection may additionally include any extraction steps for separating the object from the background and surrounding objects. A quality of fit relative to the detected object and behavior may be determined (step 956). The determination may include analyzing the shape (step 958) or the movement (step 960) of the object and classifying the object based on the quality of fit (step 962). Analyzing the shape may include determining if the object is of a rectangular, elliptical, or other geometric shape, determining the center of mass of the object, or otherwise. For example, the shape and movement of an employee may be used to determine that the object is a person and that the employee is in a specific location on the site.

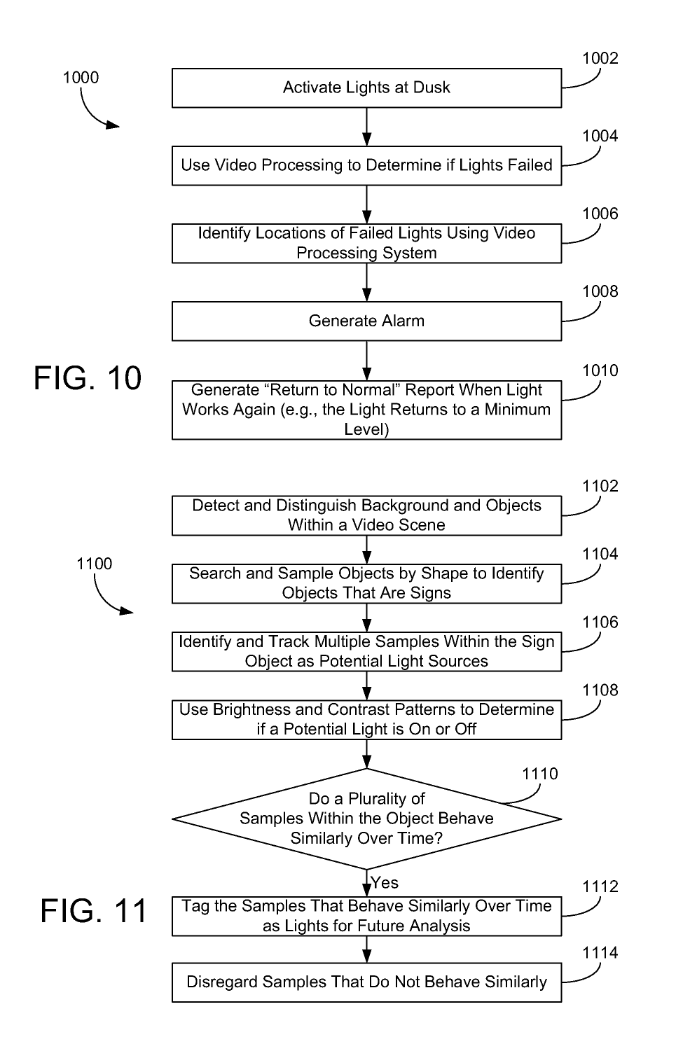

Referring to FIG. 10, a flow chart of a process 1000 for checking light functionality is shown, according to an exemplary embodiment. Process 1000 may begin when the lights are activated at dusk (step 1002) or another time when the lights should be on. Video processing may be used to detect whether a light has failed (e.g., totally off, not bright enough, etc.)(step 1004). If there is such a failed or dim light or lights, the location of the failed light or lights may be identified (step 1006) and an alarm may be generated (step 1008). The generated alarm may be sent from the video processing system to the remote monitoring system or service scheduling system. At a later date or time, the video processing system will detect when the lights have been serviced and are active. In response to such a detection, the video processing system can generate a “return to normal” message or report when the lights are determined to be on or to have returned to a normal light level (step 1010).

Referring now to FIG. 11, a detailed flow chart of a process 1100 for sign and sign light detection is shown, according to an exemplary embodiment. Process 1100 may be used to detect signs and sign lights from background video information for further analysis. Process 1100 includes detecting objects and a background within a video scene and distinguishing the two (step 1102). Areas within the detected objects may be sampled to determine the type of objects (e.g., if the object is a sign or sign light, or something else)(step 1104). For example, the sampling may include comparisons to the dimensions or shape of a sign (e.g., correlation matching, corner matching, etc.). Process 1100 further includes identifying and tracking multiple samples within the sign objects as potential light sources (step 1106). Process 1100 further includes detecting brightness and contrast patterns and using the patterns to determine if the object is a potential light source (and if the light source is on or off) (step 1108). If a plurality of sample points gathered during the sampling over time behave similarly (e.g., multiple sample points have the same brightness and contrast patterns) (step 1110), it may be determined that the object is a light source associated with the sign. The samples that behaved similarly over time may be tagged as lights for future analysis (step 1112) and samples that do not behave similarly may be disregarded (step 1114). Process 1100 may be conducted at a specific time interval (e.g., once a day, once a week, etc.). Process 1100 may additionally include logic for discarding a scene if movement of potential sign lights is detected.

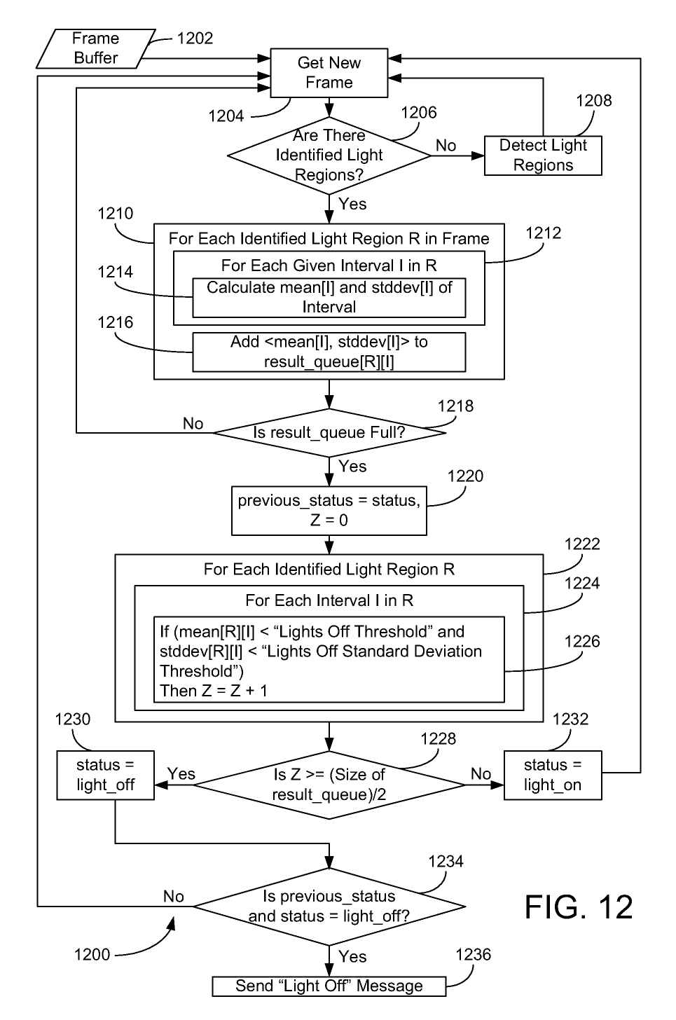

Referring to FIG. 12, a flow chart of a process 1200 for determining if a light is out and sending a notification regarding a lighting outage is shown, according to an exemplary embodiment. A frame buffer may receive frames from a video processing system and store the frames (step 1202). A new frame may be retrieved (step 1204) and process 1200 may determine if there are any identified light regions within the frame (step 1206). If there are no identified light regions, light regions may be detected (step 1208). The detection of light regions may be completed by, for example, process 1100 of FIG. 11.

If light regions are identified, for each identified light region R of the frame (step 1210), process 1200 includes analyzing each interval I in region R (step 1212). An interval may be a series of pixels, a block of video information, a portion (e.g., quarter) of a region, or another region portion. For each interval I, a mean (mean[I]) and standard deviation (stddev[I]) of the interval is calculated (step 1214). The mean is used to determine the intensity or brightness of the light source, and the standard deviation is used to determine the consistency of the light coming from the light source. The mean and standard deviation pair is then added to a queue (result_queue[R][I]) for storing calculated mean and standard deviation information of each interval of each region (step 1216). After each interval and region are analyzed, process 1200 checks for whether the queue is full (step 1218). The queue may be determined to be full if a threshold number of regions and intervals have been added to the queue. For example, the threshold may be set at the number of regions or intervals required to make a proper determination of a light status. If not enough regions or intervals are identified in a frame, process 1200 will determine that the queue is not full at step 1218 and then conduct the step of getting a new frame (step 1204) to add more regions and intervals. If the queue is full, the current light status is saved as the previous light status (previous_status) and a counting variable Z is set to zero (step 1220).

Process 1200 includes, for each identified interval I in region R (steps 1222, 1224), comparing the mean and standard deviation of the interval to thresholds relating to a “lights off” status (step 1226). If the mean is less than a given “lights off” threshold (relating to the intensity of the light) and the standard deviation is less than a given “lights off standard deviation” threshold (relating to the consistency of the intensity of the light), then counting variable Z is increased by one. Z is used to count the number of instances of a “lights_off” status for the total number of intervals in the queue. If Z is greater than or equal to half the size of the queue (result_queue)(step 1228), the status may be set to “light_off” (step 1230). If Z is less than half the size of the queue, the status may be set to “light_on” (step 1232) and process 1200 may retrieve a new frame (step 1204).

If the status is set to “light_off,” process 1200 may check for whether the previous status was also “light_off” (step 1234). If both statuses are “light_off,” process 1200 estimates that a light source is actually off and may send a message to a remote monitoring system or service scheduling system that the light is off (step 1236). If the previous status was “light_on,” process 1200 retrieves a new frame (step 1204) and repeats, and may change the previous status to “light_off” in the next iteration at step 1220.

Process 1200 may be repeated at a given time interval (e.g., every ten seconds, every minute, every five minutes, etc.). Process 1200 may be repeated to avoid false positives (e.g., in order to prevent determining the lights are off when they are actually on, process 1200 requires that two consecutive iterations of the process need to determine that the light is off before sending a message that the lights are off). For example, if a truck passes by a light and obstructs the view of the light from the point of view of a camera, the video processing system may grab a frame from the video camera and incorrectly determine the lights were off for that particular iteration in process 1200. The time intervals may prevent such results. Accordingly, in some cases consecutive frames are not stored or used by process 1200 but rather frames separated by a delay interval are used.

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures may show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

1. A computer system for providing service management to a site having a plurality of lights, the computer system comprising:
a camera; and
a processing system configured to receive frames captured by the camera and to process the frames over a period of time to detect frame locations that correspond to lights;
wherein the processing system is further configured to monitor the frame locations that correspond to lights to determine whether one or more of the lights are off at a time when the lights are scheduled to be on; and
wherein the processing system is further configured to transmit a notification message in response to a determination that the one or more lights are off at a time when the lights are scheduled to be on.

2. The computer system of claim 1, further comprising:
a monitoring system configured to receive the notification message and to cause a service event to be scheduled in response to the notification message.

3. The computer system of claim 1, wherein the processing system is configured to count determinations that the one or more lights are off over a period of time and to refrain from transmitting a notification message in response to the determination that the one or more lights are off unless the count is above a threshold value.

4. The computer system of claim 1, wherein the processing system is configured to detect which frame locations correspond to lights by distinguishing between background portions of a frame and portions of the frame that may be lights.

5. The computer system of claim 4, wherein the processing system is further configured to track brightness and contrast patterns for a portion of the frame that may be a light to determine when the potential light is estimated to be on and when the potential light is estimated to be off.

6. The computer system of claim 4, wherein the processing system is further configured to refine the frame portions that may be lights by determining if sample frame portions behave similarly during the estimated on and off times.

7. The computer system of claim 6, wherein the processing system is configured to determine the need for recalculation of frame locations that correspond to lights.

8. The computer system of claim 6, wherein the processing system periodically recalculates the frame locations that correspond to lights.

9. A computer system for monitoring a worker driven process, the computer system comprising:
a camera; and
a processing system configured to receive video of an area to be serviced by an employee and to identify a worker object within the received video by comparing an object within the video to pre-defined worker templates;
wherein the processing system is further configured to analyze the activity of the identified worker object to determine whether the activity fits within a set of process parameters for the worker driven process; and
wherein the processing system is further configured to provide a result of the determination to at least one of another system, a memory device, or a formatted report.

10. A computer system for providing service management to a plurality of distributed sites, comprising:
a video processing system at each of the plurality of distributed sites configured to analyze equipment contained at the sites; and
a monitoring system configured to receive results of the analyses from the video processing systems;
wherein the monitoring system is configured to cause service events to be scheduled for the plurality of sites based on the received results.

11. The computer system of claim 10, wherein the monitoring system is further configured to generate an aggregate report of at least one of equipment performance for the plurality of distributed sites or service statistics for the plurality of distributed sites.

12. The computer system of claim 10, wherein the equipment comprises lighting for the sites and wherein each video processing system is configured to determine whether the lighting for its site is off when the lighting is scheduled to be on.

13. A service management system for providing service management to a site, the service management system comprising:
a camera capturing video of the site;
a monitoring system remote from the camera and the site; and
a video processing system configured to analyze the video for one or more conditions and, in response to a determination that the one or more conditions have been met, to cause a data message to be sent to the monitoring system;
wherein the monitoring system is configured to cause a service event relating to the one or more conditions to be scheduled for the site.

14. The service management system of claim 13, wherein the video processing system is local to the site and the camera.

15. The service management system of claim 14, wherein the monitoring system receives data messages from a plurality of video processing systems local to a plurality of sites.

16. The service management system of claim 15, wherein the monitoring system causes a service event to be scheduled by transmitting data describing the need for service to a service provider local to the site.

17. A method for providing service management to a site, comprising:
capturing video of the site using a video camera;
providing the video to a video processing system;
using the video processing system to analyze the video for one or more conditions;
using the analysis to determine whether the one or more conditions have been met;
causing a data message to be sent to a monitoring system from the video processing system in response to a determination that the one or more conditions have been met; and
using the monitoring system to cause a service event relating to the one or more conditions to be scheduled for the site.

18. The method of claim 17, wherein the video processing system is local to the site and the camera.

19. The method of claim 18, wherein the monitoring system receives data messages from a plurality of video processing systems local to a plurality of sites.

20. The method of claim 19, wherein the monitoring system causes a service event to be scheduled by transmitting data describing the need for service to a service provider local to the site.
